(19) United States
(12) Patent Application Publication
(10) Pub. No.: US 2025/0246868 A1
(43) Pub. Date: Jul. 31, 2025

(54) ACTIVE-MIRROR LIGHT CONCENTRATOR FOR PUMPING LASER

(71) Applicant: LEDlas CORP., Hsinchu City (TW)

(72) Inventor: Yen-Chieh HUANG, Hsinchu City (TW)

(73) Assignee: LEDlas CORP., Hsinchu City (TW)

(21) Appl. No.: 18/422,400

(22) Filed: Jan. 25, 2024

(51) Int. Cl. H01S 3/094; H01S 3/04; H01S 3/042; H01S 3/06; H01S 3/0941

(52) U.S. Cl. CPC H01S 3/094049; H01S 3/0407; H01S 3/042; H01S 3/0606; H01S 3/061; H01S 3/0623; H01S 3/094084; H01S 3/0941

(57) ABSTRACT

A light concentrator includes two light reflectors connected to each other with an angle on one end to form a widening wedge-shaped structure with an opening aperture on the opposite end. At least one of the light reflectors is an active mirror device that includes a substrate having a smooth reflective surface, and a plurality of light-emitting elements disposed on the smooth reflective surface. The light emitted by the light-emitting elements is reflected, amplified, and concentrated toward the opening aperture for pumping a crystal to generate laser radiation. The widening wedge-shaped structure of the light concentrator may be filled with luminescent materials to convert the light of a wavelength from the light-emitting elements into luminescence light of another wavelength for pumping a crystal to generate laser radiation.

### FIELD

The disclosure relates to a light concentrator for pumping laser, and more particularly to a widening wedge-shaped light concentrator that can concentrate light and output concentrated light through an opening aperture, and a laser pumping system that includes the widening wedge-shaped light concentrator.

### BACKGROUND

Optical laser pumping is a process that uses light to excite an active laser medium to raise atoms in the active medium from a low-energy level to a higher one. When nearby photons stimulate the atoms to drop back to a lower energy level, the atoms emit more photons with the same characteristics as the nearby photons. This process is called light amplification by stimulated emission of radiation or laser. For example, a solid-state laser usually utilizes either a flashlamp or a laser diode that emits pump light to optically pump a laser crystal, ultimately generating a laser beam. Typically, the laser beam is highly collimated, unlike the pump light, which sometimes scatters over a broader volume in space. The efficient operation of laser pumping hinges on effectively concentrating the pump light into the laser crystal to convert the pump light into laser radiation within the laser crystal. However, it can be a challenge when a pump light source produces diverging rays of light similar to those from a flashlamp or a light-emitting diode.

U.S. Patent Application Publication No. 2016/0322775 A1 discloses a laser amplifier side-pumped by multiple laser-diode stacks, in which the light-coupling ducts that are narrowing wedge-shaped structures guide and concentrate diverging light from large input apertures (adjacent to the laser diode stacks) toward smaller output apertures (adjacent to a laser medium). In this case, as light travels through a narrowing wedge structure, the majority of the light either escapes through the side walls of the dielectric wedge or reflects backward and exit the large input aperture. Only a limited amount of the light can actually reach and pump the laser crystal.

### SUMMARY

Therefore, an object of the disclosure is to provide a light concentrator that can alleviate at least one of the drawbacks of the prior art.

According to the disclosure, the light concentrator includes two light reflectors connected to each other with an angle on one end of the light concentrator to form a widening wedge-shaped structure with an opening aperture on an opposite end of the light concentrator. Each of the light reflectors has a surface for light incident thereupon to produce reflected light. At least one of the light reflectors is an active mirror device that includes a substrate having a smooth reflective surface, and a plurality of light-emitting elements disposed on the smooth reflective surface of the substrate. Each of the light-emitting elements includes a bottom reflector that is provided on the substrate, and an active layer that is disposed on the bottom reflector. The active layer actively generates actively emitted light when an electric current is applied.

Therefore, the reflective surface of the substrate and the light-emitting elements all reflect incident light to produce reflected light. In particular, each of the light-emitting elements can amplify incident light, when the incident light is reflected by the bottom reflector and re-enters the active layer, to produce amplified reflected light. Each time, the light is amplified when the incident light traverses the active layer. Concentrated light that includes one of the actively emitted light, the reflected light, the amplified reflected light, and any combination thereof exits the widening-wedge light concentrator through the opening aperture.

Another object of the disclosure is to provide the active mirror device mentioned above.

Yet another object of the disclosure is to provide a laser pumping system. According to the disclosure, the laser pumping system includes a laser crystal and at least one light concentrator mentioned above. The opening aperture of at least one of the at least one light concentrator is adjacent to the laser crystal. Concentrated light exiting the opening aperture of the light concentrator enters the laser crystal to provide laser gain.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of a light concentrator according to the disclosure.

FIG. 2 is an exploded schematic view of the light concentrator, illustrating the disassembly of a top one of two light reflectors.

FIG. 3 is a top view illustrating an embodiment of an active mirror device including an array of light-emitting elements on a reflecting layer which is on a substrate layer according to the disclosure.

FIG. 4 is a cross-sectional view illustrating one of the light-emitting elements according to one embodiment of the disclosure.

FIGS. 5 to 8 are schematic views illustrating various embodiments of a light concentrator according to the disclosure.

FIGS. 9 and 10 are schematic views illustrating an embodiment of a laser pumping system adopting one light concentrator according to the disclosure.

FIGS. 11 to 16 are cross-sectional views illustrating other embodiments of a laser pumping system adopting multiple light concentrators according to the disclosure.

### DETAILED DESCRIPTION

Before the disclosure is described in greater detail, it should be noted that, wherever considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “right,” “left,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

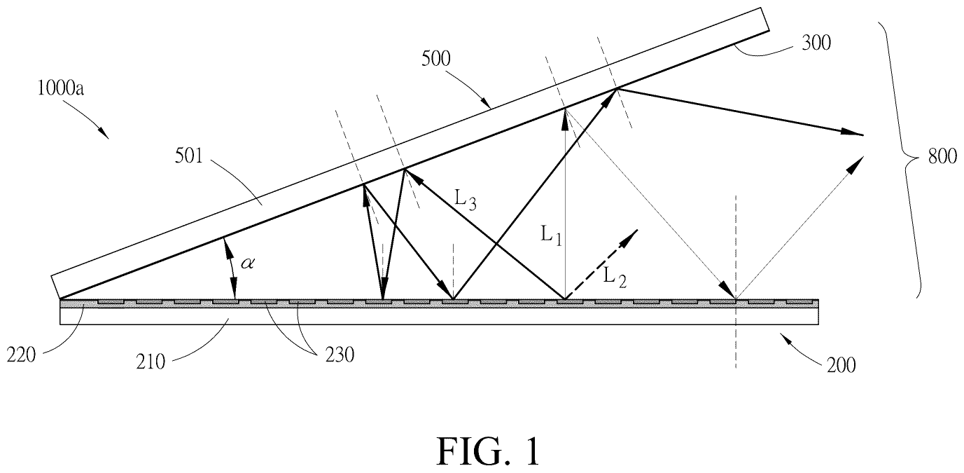

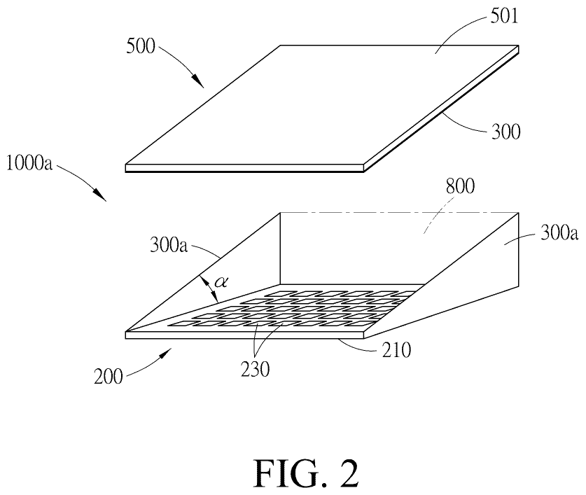

Referring to FIGS. 1 and 2, an embodiment of a light concentrator 1000a according to the disclosure includes two light reflectors connected to each other with an angle α on the left end, as illustrated in FIG. 1, to form a widening wedge-shaped structure to guide light toward an opening aperture 800 on the right end of the light concentrator 1000a. It is noted that the term “opening” refers to a gradually enlarging passage for light propagating in the widening wedge-shaped structure. In some embodiments, the angle α falls within a range of greater than 0 degrees and less than 90 degrees. Specifically, the light reflectors may be connected directly or indirectly on the left end (through an intermediary). The two lateral sides of the wedge-shaped structure may be covered by two reflective layers 300a including materials, such as dielectric or metal.

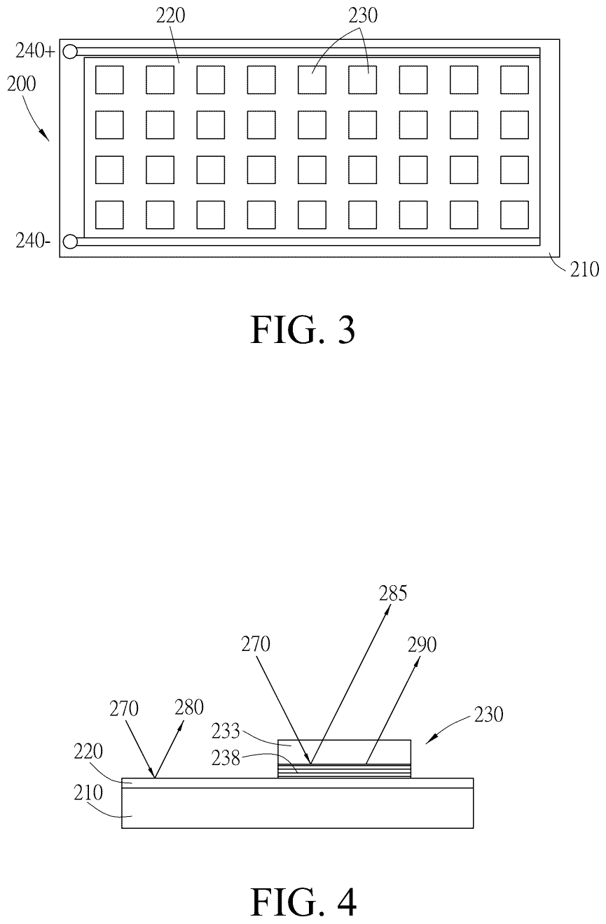

In this embodiment, one of the light reflectors (e.g., the bottom one) is an active mirror device 200 as shown in FIGS. 3 and 4, and the other light reflector (e.g., the top one) is a mirror reflector 500 that includes a base layer 501 with a smooth surface (e.g., the lower surface), such as a glass plate, and a high-reflection layer 300 coated on the smooth surface of the base layer 501. A material of the high-reflection layer 300 and reflective layers 300a may include at least one of dielectric, aluminum (Al), silver (Ag), or gold (Au) films, etc. In one embodiment, the active mirror device 200 is attached to a cooling plate (not shown) for heat removal from light-emitting elements 230.

Specifically, the active mirror device 200 includes a substrate which includes a substrate layer 210 and a reflecting layer 220 on the substrate layer 210, and an array of light-emitting elements 230 which is disposed on and bonded to the reflecting layer 220. As shown in FIG. 3, the active mirror device 200 functions as a planar light source. When powered by a power supply (not shown) through appropriate wiring, the light-emitting elements 230 emit light 290 (FIG. 4), which will hereinafter also be referred to as “actively emitted light 290.”

In this embodiment, the substrate layer 210 has high thermal conductivity for efficient heat dissipation of the light-emitting elements 230. The reflecting layer 220 has a smooth reflective surface, and may be a metal film, such as silver or gold, which has both high thermal conductivity and high reflectivity. Each of the light-emitting elements 230 may include a built-in bottom reflector 238, which is provided on the reflecting layer 220 and directs light upwards, and an active layer 233 which is disposed on the bottom reflector 238. In some embodiments, the active layer 233 may include, but not limited to, a P-type semiconductor layer, an N-type semiconductor layer, and an active region formed between the P-type semiconductor layer and the N-type semiconductor layer. The active layer 233 actively generates the actively emitted light 290 when an electric current is applied. A material of the active layer 233 may include a conductor or semiconductor material, such as Al, In, Ga, As, Ze, Se, P, or any combination thereof. The bottom reflector 238 may include one of a gold layer, a distributed Bragg reflector (DBR), and a combination thereof. It is noted that FIG. 4 is not drawn to scale, and the relative size of the light-emitting elements 230 with respect to the substrate layer 210 is exaggerated for clarity; in reality, the light-emitting elements 230 are extremely thin, with an order of magnitude between a few hundred nanometers and a few microns. It should be noted that, in some embodiments, the substrate layer itself has a smooth reflective surface, and the plurality of light-emitting elements are disposed on and bonded to the smooth reflective surface of the substrate layer, and hence no reflecting layer is required.

The opening aperture 800 of the light concentrator 1000a is, for example, at the right end of the light concentrator 1000a, as shown in FIG. 1. When a light ray is emitted vertically (marked as L₁) from one of the light-emitting elements 230 of the active mirror device 200 that is positioned at the bottom, based on the law of reflection (i.e., the angle of reflection is equal to the angle of incidence), the light ray (L₁) takes a zigzag path and travels to the opening aperture 800 with the angles of incidence and reflection being progressively larger on the surfaces of the two light reflectors. When a light ray is emitted toward the upper-right direction (marked as L₂), the light ray (L₂) travels directly to the opening aperture 800, or exits the opening aperture 800 after one or a few reflections on the surfaces of the two light reflectors. When a light ray is emitted toward the upper-left direction (marked as L₃), the angles of incidence and reflection become progressively smaller until the light ray (L₃) is converted to a right-propagating ray, and eventually exits the opening aperture 800.

In this way, the light emitted from the light-emitting elements 230 can eventually exit through and only through the opening aperture 800, which is at the right end of the light concentrator 1000a. Therefore, the light concentrator 1000a according to the disclosure is a unidirectional light guide and concentrator. Furthermore, in the direction in which concentrated light is guided toward the opening aperture 800 of the light concentrator 1000a, the wedge-shaped structure exhibits a widening shape. That is to say, the light inside the structure always travels and concentrates toward a widening wedge structure.

Referring to FIGS. 1 and 4, the actively emitted light 290 from one of the light-emitting elements 230 may become an incident light 270 on the high-reflection layer 300 or the reflecting layer 220 of the light concentrator 1000a. In the case of the active mirror device 200, it is the reflecting layer 220 that reflects the incident light 270 to produce a reflected light 280. In some occasions, the incident light 270 is incident on one light-emitting element 230 and traverses the active layer 233 thereof. The active layer 233 then amplifies the reflected light to form an amplified reflected light 285, because the active layer 233 is a gain medium for generating light. Thus, the active mirror device 200 can serve as a combination of a light emitter, a light reflector, and a light amplifier. Concentrated light, which includes one of the actively emitted light 290, the reflected light 280, the amplified reflected light 285 and any combination thereof, is guided to exit the light concentrator 1000a through the opening aperture 800.

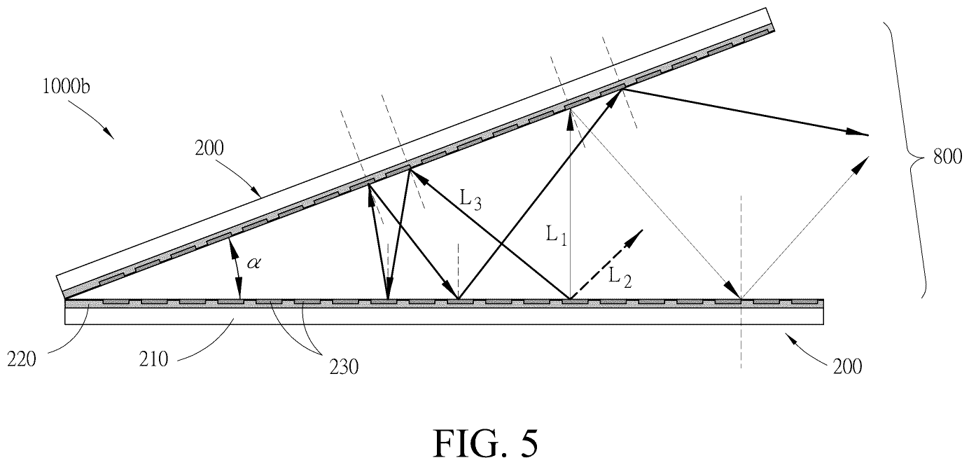

Referring to FIG. 5, in one embodiment, a light concentrator 1000b includes two light reflectors that are both active mirror devices 200. That is, the mirror reflector 500 of the light concentrator 1000 a in FIG. 1 is replaced with another active mirror device 200. In this embodiment, as both light reflectors are active mirror devices 200, the overall amount of light emitted, reflected, and amplified is increased. Thus, the intensity of light exiting the opening aperture 800 of the light concentrator 1000b is also proportionally increased.

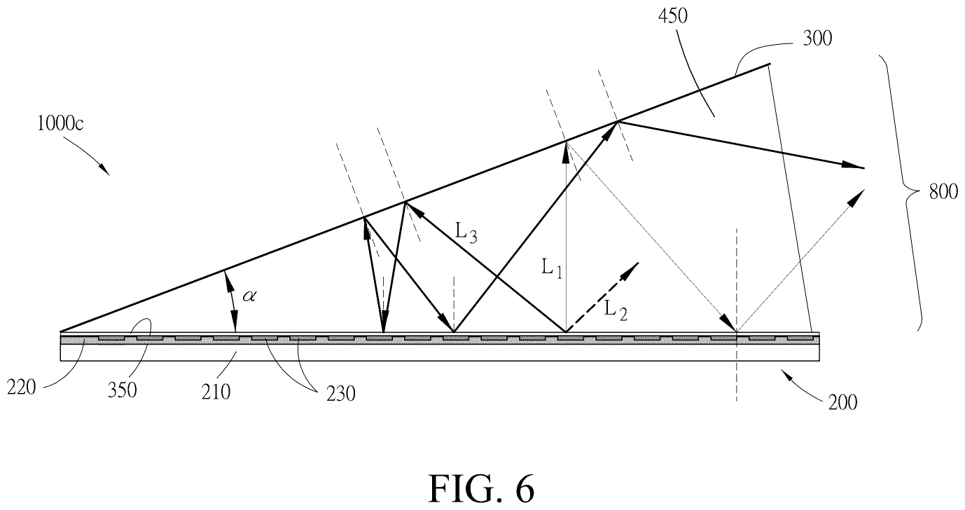

Referring to FIG. 6, in one embodiment, a light concentrator 1000c includes two light reflectors and a dielectric wedge 450 between the two light reflectors. The two light reflectors of the light concentrator 1000c are respectively an active mirror device 200 (positioned at the bottom) and a high-reflection layer 300 (positioned at the top) coated on an upper surface of the dielectric wedge 450. A material of the high-reflection layer 300 may include at least one of Al, Ag, Au, or dielectric, etc., so as to reflect the light emitted from the active mirror device 200. The dielectric wedge 450 is filled in a space between the two light reflectors. The dielectric wedge 450 may be made of a dielectric material, such as glass or plastic, transparent to light. Additionally, the light concentrator 1000c further includes an anti-reflection layer 350 coated on a lower surface of the dielectric wedge 450, so as to enhance light transmission and minimize reflection loss between the dielectric wedge 450 and the active mirror device 200.

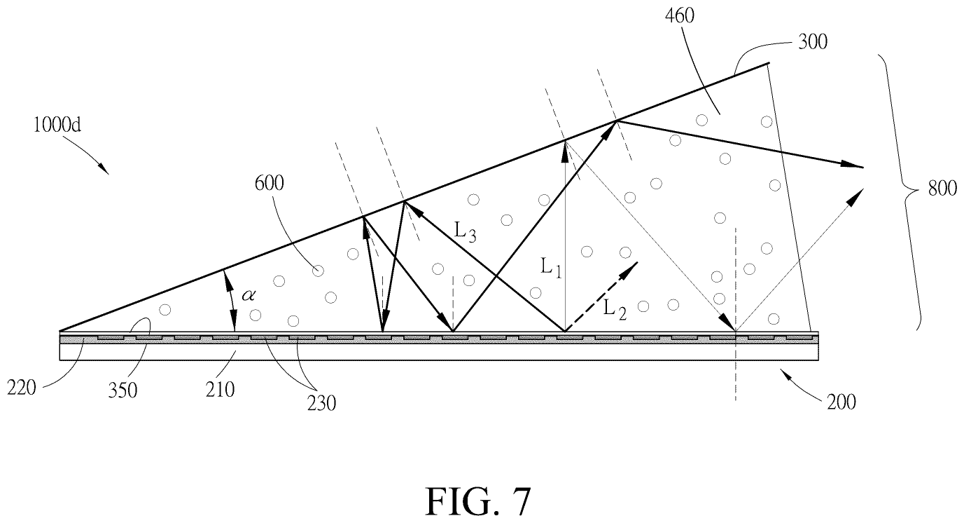

Referring to FIG. 7, in one embodiment, a light concentrator 1000d includes two light reflectors same as those of the light concentrator 1000c described above, a luminescent wedge 460, and an anti-reflection layer 350 coated on a bottom surface of the luminescent wedge 460. That is, the dielectric wedge 450 of the light concentrator 1000c in FIG. 6 is replaced by the luminescent wedge 460 to obtain the light concentrator 1000d. Specifically, the luminescent wedge 460 includes a wedge similar to the dielectric wedge 450 doped with luminescent elements 600, such as fluorescent, phosphorescent dyes or quantum dots. The luminescent elements 600 convert the actively emitted light 290 of a wavelength from the active mirror device 200 into luminescence light of another wavelength. The luminescence light is then guided and concentrated toward the opening aperture 800. For instance, the active mirror device 200 may emit blue light, and the luminescent elements 600 that include cerium-doped yttrium aluminum garnet (Ce:YAG) may be excited by the blue light to generate luminescence in the yellow-orange-red spectrum. Yellow-orange-red light is then guided by the light concentrator 1000d toward the opening aperture 800.

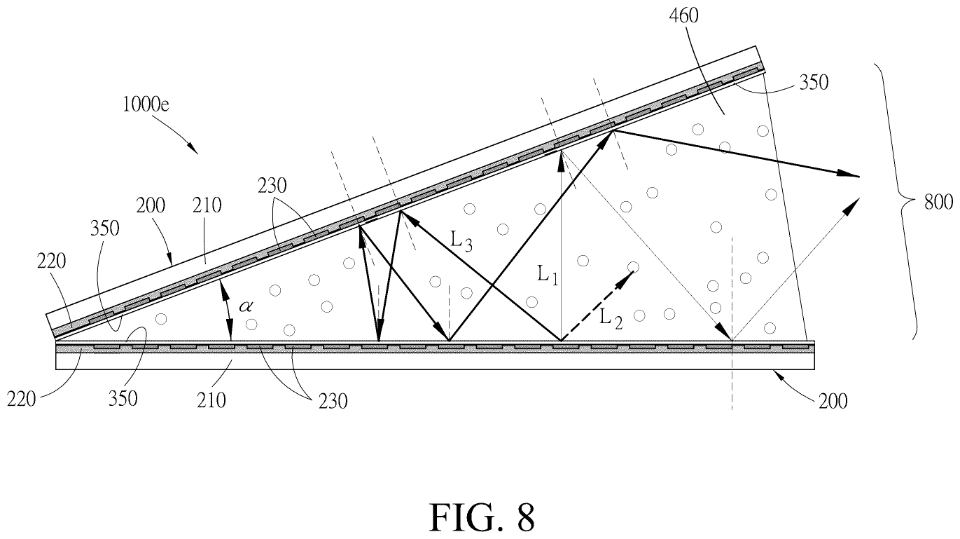

Referring to FIG. 8, in one embodiment, a light concentrator 1000e includes two light reflectors, a luminescent wedge 460 as described above. In this embodiment, the two light reflectors are both active mirror devices 200. For enhancing light transmission and minimizing light loss due to reflections, two anti-reflection layers 350 may be coated on a bottom surface and a top surface of the luminescent wedge 460, respectively.

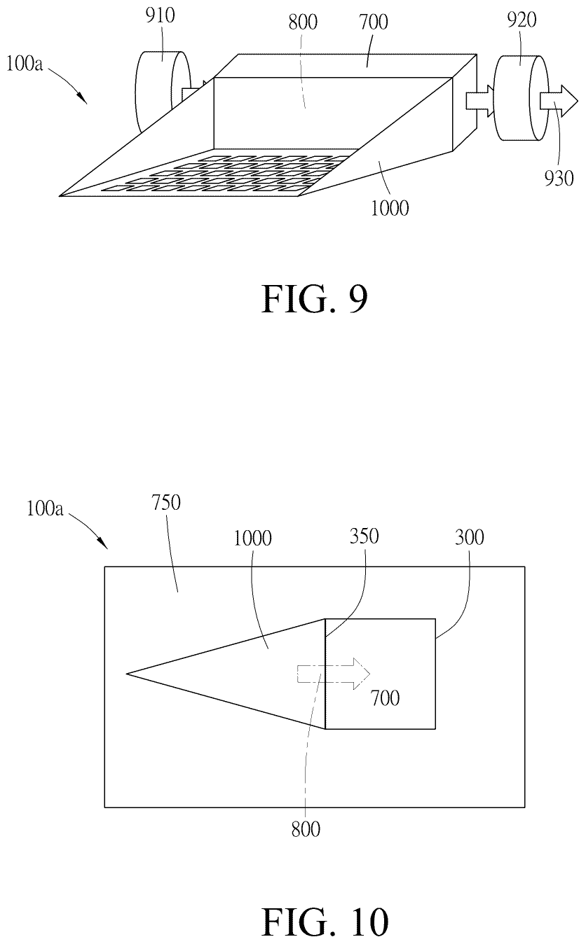

Each of the light concentrators 1000a, 1000b, 1000c, 1000d and 1000e mentioned above (hereinafter referred to as “light concentrator 1000”) is ideal for pumping a laser crystal. Referring to FIGS. 9 and 10, in one embodiment, a single-side laser pumping system 100a includes a laser crystal 700 with a rectangular cross section, the light concentrator 1000, and a cooling housing 750 for heat dissipation (not shown in FIG. 9). FIG. 10 is a cross sectional view of FIG. 9 showing a cut across the rectangular aperture of the laser crystal 700 and further showing the cooling housing 750. The laser crystal 700 and the light concentrator 1000 are installed in the cooling housing 750 for heat dissipation.

The laser crystal 700 has four side surfaces that are front, rear, top and bottom side surfaces, and is installed in a laser cavity formed by two cavity mirrors 910 and 920. The opening aperture 800 of the light concentrator 1000 is adjacent to one of the side surfaces of the laser crystal 700, e.g., the front-side surface. The light concentrator 1000 outputs pump light (i.e., the concentrated light mentioned above) through the opening aperture 800 to the laser crystal 700, and the laser crystal 700 in the laser cavity absorbs the pump light to generate laser radiation 930 via stimulated emission. In this embodiment, the single-side laser pumping system 100a further includes an anti-reflection layer 350 and a high-reflection layer 300 coated on the front-side and rear-side surfaces of the laser crystal 700, respectively. The anti-reflection layer 350 is to increase the pump-light transmission into the laser crystal 700, and the high-reflection layer 300 is to reflect and re-use the unabsorbed pump light in the laser crystal 700.

The laser crystal 700 may be one of a neodymium-doped YAG (Nd:YAG) crystal, a ytterbium-doped YAG (Yb:YAG) crystal, a holmium-chromium-thulium triple-doped YAG (Ho:Cr:Tm:YAG) crystal, a neodymium-doped yttrium orthovanadate (Nd:YVO₄) crystal, an erbium-doped YAG (Er:YAG) crystal, a chromium-doped colquiriite (Cr:LiSAF) crystal, a titanium-doped sapphire (Ti:sapphire) crystal, a chromium crystal, an erbium:yttrium scandium gallium garnet (Cr, Er:YSGG) crystal, an alexandrite crystal, an erbium-doped phosphate glass (Er:glass) crystal, etc.

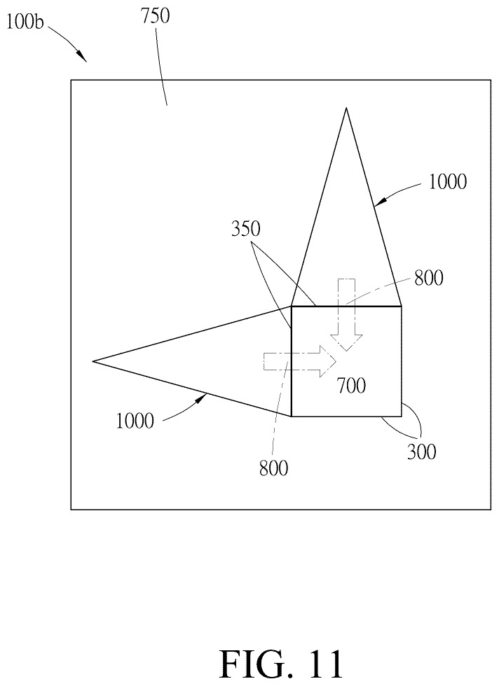

The laser pumping capability can be enhanced by employing multiple light concentrators 1000. Referring to FIG. 11 for the cross-sectional view of one embodiment, a double-side laser pumping system 100b includes the laser crystal 700 with a rectangular cross section, two light concentrators 1000, and the cooling housing 750 for heat dissipation. The two light concentrators 1000 are positioned at two adjacent sides of the laser crystal 700. For example, the opening apertures 800 of the light concentrators 1000 are adjacent to, specifically are arranged to face the front-side surface and the top-side surface of the laser crystal 700. The double-side laser pumping system 100b further includes two anti-reflection layers 350 coated on the front-side surface and the top-side surface of the laser crystal 700, and two high-reflection layers 300 coated on the rear-side surface and the bottom-side surface of the laser crystal 700. The anti-reflection layers 350 are to increase the pump-light transmission into the crystal, and the high-reflection layers 300 are to reflect and re-use the unabsorbed pump light in the laser crystal 700. Each of the light concentrators 1000 outputs pump light (i.e., the concentrated light mentioned above) through the opening aperture 800 to the laser crystal 700, and the laser crystal 700 in a laser cavity absorbs the pump light to generate laser radiation 930 (FIG. 9) via stimulated emission.

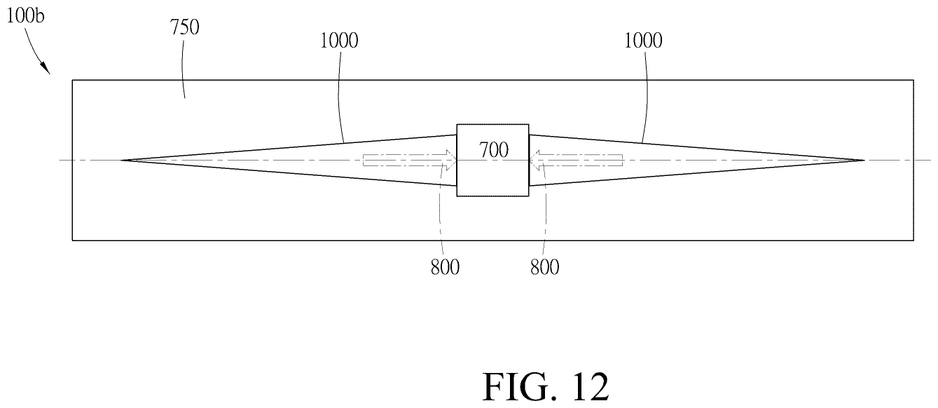

In another embodiment, the two light concentrators 1000 are oppositely aligned and positioned at two opposite sides of the laser crystal 700. For example, as shown in FIG. 12, which illustrates the cross-sectional view of one embodiment, the opening apertures 800 of the light concentrators 1000 are arranged to face the front-side surface and the rear-side surface of the laser crystal 700, respectively in such a way that pump light emitted by both light concentrators 1000 is directed to pump the laser crystal 700.

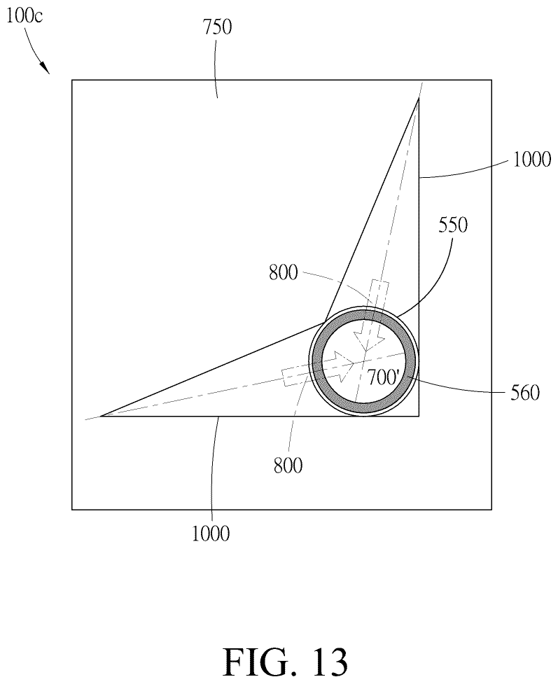

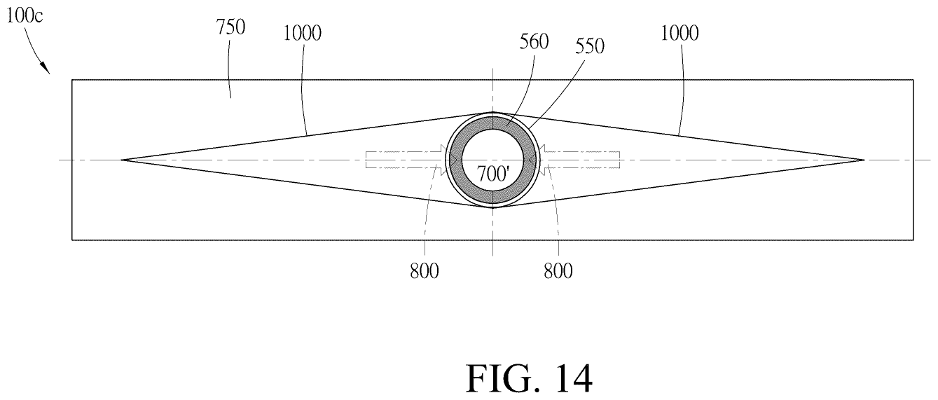

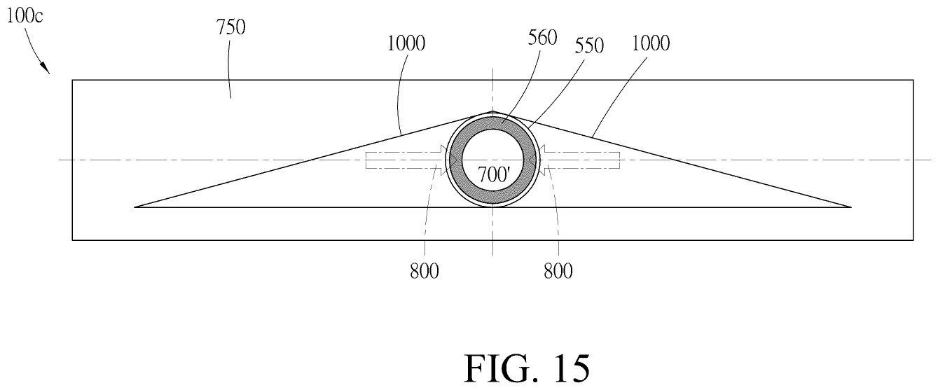

Referring to FIGS. 13, 14 and 15 for the cross-sectional views of some embodiments, a laser pumping system 100c includes a laser crystal 700′ with a circular cross section, two light concentrators 1000, and the cooling housing 750 for dissipating heat from the active mirror devices. In one embodiment, the laser pumping system 100c may further include a transparent tube 550 with cooling liquid 560 flowing therethrough for removing heat from the laser crystal 700′, and the laser crystal 700′ is installed by means of, for instance, a rubber seal, in the transparent tube 550. The opening apertures 800 of the light concentrators 1000 are adjacent to the laser crystal 700′, specifically are attached to a first part and a second part of a circumferential surface of the transparent tube 550, respectively. The first part and the second part may each constitute, for example but not limited to, one-third of the circumferential surface of the transparent tube 550, as shown in FIG. 13, or one-half of the circumferential surface of the transparent tube 550 as shown in FIG. 14 and FIG. 15. In one embodiment as shown in FIG. 15, the bottom ones of the light reflectors of the light concentrators 1000 are on the same horizontal plane.

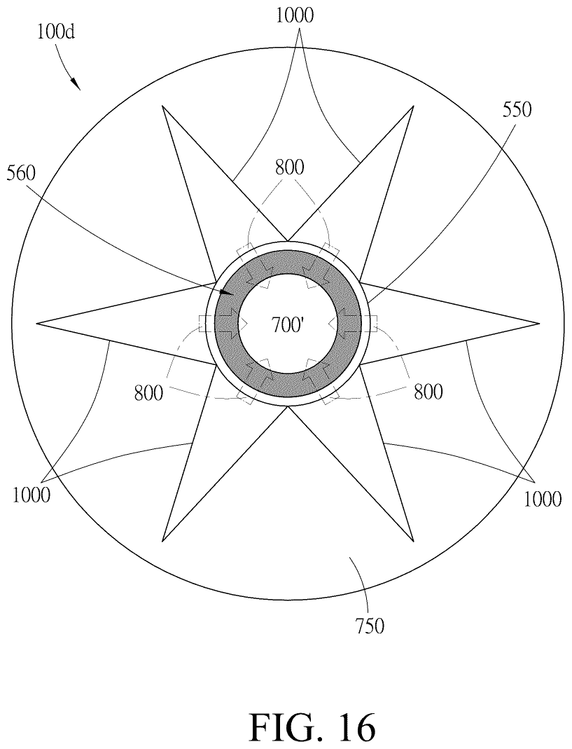

Referring to FIG. 16 for the cross-sectional view of one embodiment, a multi-side laser pumping system 100d includes a laser crystal 700′ with a circular cross section, more than two light concentrators 1000, the transparent tube 550 with cooling liquid 560 flowing therethrough for removing heat from the laser crystal 700′, and the cooling housing 750 for dissipating heat from the active mirror devices. The opening apertures 800 of the light concentrators 1000 are attached to the circumferential surface of the transparent tube 550, and the pump light emitted by all of the light concentrators 1000 is directed to the laser crystal 700′.

As described, with the light concentrator 1000 having the active mirror device 200 forming a widening wedge-shaped structure, all light in the structure is effectively concentrated toward the laser crystal 700 through the opening aperture 800, thereby achieving highly efficient laser pumping.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

What is claimed is:

1. An active mirror device, comprising:
a substrate having a smooth reflective surface; and
a plurality of light-emitting elements disposed on said smooth reflective surface of said substrate, each of said light-emitting elements including a bottom reflector that is provided on said substrate, and an active layer that is disposed on the bottom reflector, said active layer actively generating actively emitted light when an electric current is applied;
wherein said reflective surface of said substrate reflects light incident thereupon to produce reflected light, and for each of said light-emitting elements, said bottom reflector reflects light incident thereupon into said active layer, which amplifies the light reflected by said bottom reflector to produce amplified reflected light.

2. The active mirror device as claimed in claim 1, wherein said bottom reflector includes one of a gold layer, a distributed Bragg reflector (DBR), and a combination thereof.

3. The active mirror device as claimed in claim 1, wherein said active layer includes a gain medium for generating light.

4. The active mirror device as claimed in claim 1, wherein said substrate includes a substrate layer having high thermal conductivity for heat dissipation of said light-emitting elements, and a reflecting layer on said substrate layer, said reflecting layer having said smooth reflective surface.

5. A light concentrator, comprising:
two light reflectors connected to each other with an angle on one end of said light concentrator to form a widening wedge-shaped structure with an opening aperture on an opposite end of said light concentrator, each of said light reflectors having a surface for light incident thereupon to produce reflected light;
wherein at least one of said light reflectors is the active mirror device as claimed in claim 1, and concentrated light that includes one of the actively emitted light, the reflected light, the amplified reflected light and any combination thereof exits said light concentrator through said opening aperture.

6. The light concentrator as claimed in claim 5, wherein one of said light reflectors is said active mirror device, and the other one of said light reflectors is a mirror reflector that includes a base layer with a smooth surface and a high-reflection layer coated on the base layer.

7. The light concentrator as claimed in claim 5, further comprising:
a dielectric wedge that is transparent and filled in a space between said two light reflectors.

8. The light concentrator as claimed in claim 7, further comprising an anti-reflection layer coated on a surface of said dielectric wedge adjacent to said active mirror device.

9. The light concentrator as claimed in claim 7, wherein said dielectric wedge is doped with luminescent elements that convert the actively emitted light of a wavelength into luminescence light of a different wavelength.

10. A laser pumping system, comprising:
a laser crystal; and
at least one light concentrator each including
two light reflectors connected to each other with an angle on one end of said at least one light concentrator to form a widening wedge-shaped structure with an opening aperture on an opposite end of said at least one light concentrator, said opening aperture being adjacent to said laser crystal, each of said light reflectors having a surface for light incident thereupon to produce reflected light;
wherein at least one of said light reflectors is the active mirror device as claimed in claim 1, and concentrated light that includes one of the actively emitted light, the reflected light, the amplified reflected light and any combination thereof exits said light concentrator through said opening aperture and enters said laser crystal.

11. The laser pumping system as claimed in claim 10, further comprising an anti-reflection layer coated on a surface of said laser crystal through which the concentrated light enters said laser crystal.

12. The laser pumping system as claimed in claim 11, further comprising a high-reflection layer coated on another surface of said laser crystal opposite to said surface of said laser crystal for re-using unabsorbed pump light.

13. The laser pumping system as claimed in claim 10, wherein said laser crystal is a laser crystal with a circular cross-section; said laser pumping system further comprising a transparent tube with cooling liquid flowing therethrough, said laser crystal being installed in said transparent tube.

14. The laser pumping system as claimed in claim 13, wherein said opening aperture of said light concentrator is attached to a part of a circumferential surface of said transparent tube.

15. The laser pumping system as claimed in claim 10, wherein, for each of said at least one light concentrator, said aperture of said light concentrator is arranged to face said laser crystal in such a way that pump light emitted by said light concentrator is directed to said laser crystal.
